(19) United States
(12) Patent Application Publication
(10) Pub. No.: US 2017/0331329 A1
(43) Pub. Date: Nov. 16, 2017

(54) WIRELESS POWER TRANSMISSION APPARATUS AND METHOD FOR CONTROLLING SAME

(71) Applicant: LG ELECTRONICS INC., Seoul (KR)

(72) Inventors: Minwoo KIM, Seoul (KR); Seungyup CHANG, Seoul (KR); Changsuk LEE, Seoul (KR)

(73) Assignee: LG ELECTRONICS INC., Seoul (KR)

(21) Appl. No.: 15/529,459

(22) PCT Filed: Jan. 20, 2015
(86) PCT No.: PCT/KR2015/000585

§ 371 Date: May 24, 2017

(30) Foreign Application Priority Data
Nov. 24, 2014 (KR) 10-2014-0164719

(51) Int. Cl. H02J 50/12; H02J 7/02; H02J 50/80; H02J 50/90; H04B 5/00

(52) U.S. Cl. CPC H02J 50/12; H04B 5/0037; H04B 5/0031; H02J 50/80; H02J 50/90; H02J 7/025

(57) ABSTRACT

The present disclosure relates to a wireless power transmission apparatus provided with a data backup function, and a method for controlling the wireless power transmission apparatus. A wireless power transmission apparatus which transceives wireless signals with a mobile terminal receiving wireless power according to the present invention comprises: a first wireless communication module sensing, via near-field communication, whether the mobile terminal is in a wireless recharging region of the wireless power transmission apparatus; utilizing the detection of the mobile terminal by the first wireless communication module, a second wireless communication module receiving data stored in the mobile terminal in order to carry out backup of the data; memory for storing the data, which is stored in the mobile terminal, received by means of the second wireless communication module; a power transmission unit for transmitting wireless power to the mobile terminal in the wireless recharging region; and a control unit for controlling any one from among the first wireless communication module, second wireless communication module, memory and power transmission unit, wherein the control unit carries out, via the first wireless communication module, an authentication process with the mobile terminal by means of authentication information, for backing up data, previously stored therein, and following the completion of the authentication process, the second wireless communication module is controlled to receive data stored in the mobile terminal.

### TECHNICAL FIELD

The present invention relates to a wireless power transmission apparatus having a data backup function, and a method for controlling the same.

### BACKGROUND ART

In recent years, the method of contactlessly supplying electrical energy to wireless power receivers in a wireless manner has been used instead of the traditional method of supplying electrical energy in a wired manner.

As such, it may be considered that wireless power transmission apparatuses supplying electric energy to wireless power reception apparatuses in a wireless manner provide more various functions, through communications with wireless power reception apparatuses, as well as the function of supplying electric energy.

In addition, with the increase in use frequency of a mobile terminal, an amount of data stored in the mobile terminal increases and important data is frequently stored in the mobile terminal. Accordingly, backup and restoration operations of the data stored in the mobile terminal are getting necessary in using the mobile terminal.

Thus, it may be taken into account that devices having a wireless charging function among different types of mobile terminals and wireless power transmission apparatuses perform a backup function through data communications therebetween during wireless charging.

### DISCLOSURE OF THE INVENTION

Therefore, an aspect of the detailed description is to provide a wireless power transmission apparatus providing a data backup function, and a method for controlling the same.

Another aspect of the detailed description is to provide a wireless power transmission apparatus capable of enhancing user convenience in performing a data backup function, and a method for controlling the same.

To achieve these and other advantages and in accordance with the purpose of the present invention, as embodied and broadly described herein, there is provided a wireless power transmission apparatus configured to transmit and receive wireless signals with a mobile terminal receiving power in a wireless manner, the apparatus including a first wireless communication module configured to detect whether or not the mobile terminal is located on a wireless charging area of the wireless power transmission apparatus through short-range communication, a second wireless communication module configured to receive data stored in the mobile terminal for backing up the data stored in the mobile terminal, in response to the mobile terminal being detected through the first wireless communication module, a memory configured to store the data stored in the mobile terminal, received through the second wireless communication module, a power transmission unit configured to transmit the wireless power to the mobile terminal located on the wireless charging area, and a controller configured to control at least one of the first wireless communication module, the second wireless communication module, the memory and the power transmission unit, wherein the controller executes an authentication process with the mobile terminal using authentication information for backing up the data stored in the mobile terminal, through the first wireless communication module, and controls the second wireless communication module to receive the data stored in the mobile terminal after the authentication process is completed.

In an embodiment disclosed herein, the backup function for the data stored in the mobile terminal using the second wireless communication module may be executable even while the wireless power is transmitted from the power transmission unit to the mobile terminal.

In an embodiment disclosed herein, the controller may control the power transmission unit to stop the wireless power transmission to the mobile terminal and control the second wireless communication module to continuously execute the backup function for the data stored in the mobile terminal, when the wireless charging for the mobile terminal is completed while the backup function for the data stored in the mobile terminal using the second wireless communication module and the wireless charging function for the mobile terminal using the power transmission unit are simultaneously executed.

In an embodiment disclosed herein, the controller may output a popup window including selection information for selecting whether or not to continuously execute another non-completed function when one of the wireless charging function for the mobile terminal and the backup function for the data stored in the mobile terminal is completed.

In an embodiment disclosed herein, the controller may execute the backup function for the data stored in the mobile terminal when the charging for the mobile terminal is completed by a preset level or more using the wireless power.

In an embodiment disclosed herein, the controller may generate a log file for data stored in the memory through the backup, among the data stored in the mobile terminal, when the backup for the data stored in the mobile terminal is completed.

In an embodiment disclosed herein, the controller may decide using the log file data to be backed up among the data stored in the mobile terminal, when the backup for the data stored in the mobile terminal is re-executed after the backup for the data stored in the mobile terminal is completed.

In an embodiment disclosed herein, the controller may execute using the log file the backup for data, which is not stored in the memory, among the data stored in the mobile terminal.

In an embodiment disclosed herein, the controller may determine using the log file whether or not data to be backed up is present among the data stored in the mobile terminal when the mobile terminal is detected through the first wireless communication module, and output notification information notifying the presence of the data to be backed up when the data to be backed up is present among the data stored in the mobile terminal according to the determination result.

In an embodiment disclosed herein, the controller may execute the backup for the data to be backed up when a backup request is received from a user, in response to the output of the notification information notifying the presence of the data to be backed up.

In an embodiment disclosed herein, the first communication module may be a near field communication (NFC) communication module using a short-range communication method, and the second communication module may be a wireless-fidelity (Wi-Fi) communication module performing communication with the mobile terminal within a short-range communication network.

In an embodiment disclosed herein, the NFC communication module may be arranged to correspond to the wireless charging area, and the wireless charging area having the NFC communication module arranged thereon may be provided with a magnet therein to guide the mobile terminal to be located thereon.

In an embodiment disclosed herein, the controller may control the first wireless communication module to transmit at least one of Service Set Identifier (SSID) information, access security method information and password information related to the second wireless communication module to the mobile terminal, when it is detected through the first wireless communication module that the mobile terminal is located on the wireless charging area.

In an embodiment disclosed herein, permission request information related to the data backup function may be transmitted to the mobile terminal such that notification information for selecting whether or not to execute the backup function for the data stored in the mobile terminal is output on the mobile terminal through the second wireless communication module, when the mobile terminal is detected through the first wireless communication module.

In an embodiment disclosed herein, backup data stored in the memory through the backup for the data stored in the mobile terminal may be transmitted to an external device or external server through the second wireless communication module based on a user request.

To achieve these and other advantages and in accordance with the purpose of the present invention, as embodied and broadly described herein, there is provided a method for controlling a wireless power transmission apparatus configured to transmit and receive wireless signals with a mobile terminal receiving wireless power, the method including detecting, through a first wireless communication module executing short-range communication, whether or not the mobile terminal is located on a wireless charging area of the wireless power transmission apparatus, transmitting the wireless power to the mobile terminal located on the wireless charging area, in response to the detection of the mobile terminal through the first wireless communication module, executing an authentication process for backing up data stored in the mobile terminal, using prestored authentication information, through the first wireless communication module, and receiving the data stored in the mobile terminal for backing up the data stored in the mobile terminal through a second wireless communication module, different from the first wireless communication module, when the authentication process is completed.

In an embodiment disclosed herein, the backup function for the data stored in the mobile terminal using the second wireless communication module may be executable even while the wireless power is transmitted from a power transmission unit to the mobile terminal.

In an embodiment disclosed herein, the wireless power transmission to the mobile terminal may be stopped and the backup function for the data stored in the mobile terminal may continuously be executed, when the wireless charging for the mobile terminal is completed, while the backup function for the data stored in the mobile terminal using the second wireless communication module and the wireless charging function for the mobile terminal using the power transmission unit are simultaneously executed.

In an embodiment disclosed herein, the method may further include generating a log file for data stored in the memory through the backup, among the data stored in the mobile terminal, when the backup for the data stored in the mobile terminal is completed.

In an embodiment disclosed herein, the method may further include deciding, using the log file, data to be backed up among the data stored in the mobile terminal, when the backup for the data stored in the mobile terminal is re-executed after the backup for the data stored in the mobile terminal is completed.

### Advantageous Effect

In accordance with the detailed description, a wireless power transmission apparatus according to the present invention may detect that a wireless power reception apparatus is located on a wireless charging area through a short-range communication module, and perform a backup function for data stored in the wireless power reception apparatus in response to the detection. That is, according to the present invention, the data backup function can be performed simultaneously with a wireless charging for the wireless power reception apparatus. Therefore, a user can save time taken by executing the wireless charging function and the data backup function by virtue of the simultaneous use of the both functions.

Further, when the wireless power reception apparatus is detected through the short-range wireless communication module, the wireless power transmission apparatus according to the present invention can perform the data backup function for the wireless power reception apparatus by activating another communication module having a data communication speed higher than that of the short-range wireless communication module. Therefore, according to the present invention, the data backup function can be provided more efficiently by virtue of appropriately using the communication modules for a utilization purpose.

### BRIEF DESCRIPTION OF THE DRAWINGS

FIG. 1 an exemplary view conceptually illustrating a wireless power transmitter (or a wireless power transmission apparatus) and a wireless power receiver (or a wireless power reception apparatus) according to the embodiments of the present invention.

FIGS. 2A and 2B are exemplary block diagrams illustrating the configuration of a wireless power transmitter and a wireless power receiver that can be employed in the embodiments disclosed herein, respectively.

FIG. 3 is a view illustrating a concept in which power is transferred from a wireless power transmitter to a wireless power receiver in a wireless manner according to an inductive coupling method.

FIGS. 4A and 4B are block diagrams illustrating partial configurations of a wireless power transmitter and a wireless power receiver in a magnetic induction method that can be employed in the embodiments disclosed herein.

FIG. 5 is a block diagram illustrating a wireless power transmitter configured to have one or more transmitting coils receiving power according to an inductive coupling method that can be employed in the embodiments disclosed herein.

FIG. 6 is a view illustrating a concept in which power is transferred to a wireless power receiver from a wireless power transmitter in a wireless manner according to a resonance coupling method.

FIGS. 7A and 7B are block diagrams illustrating partial configurations of a wireless power transmitter and a wireless power receiver in a resonance method that can be employed in the embodiments disclosed herein.

FIG. 8 is a block diagram illustrating a wireless power transmitter configured to have one or more transmitting coils receiving power according to a resonance coupling method that can be employed in the embodiments disclosed herein.

FIG. 9 is a block diagram illustrating a wireless power transmitter according to the present invention.

FIGS. 10A and 10B are conceptual views illustrating a wireless power transmitter according to the present invention.

FIGS. 11 and 12 are flowcharts each illustrating a method of performing a backup function in the wireless power transmitter illustrated in FIGS. 10A and 10B.

FIGS. 13A, 13B, 13C, 14A, 14B and 15 are conceptual views each illustrating a method of performing a data backup function in a wireless power transmitter or a wireless power receiver according to the present invention.

### MODES FOR CARRYING OUT THE PREFERRED EMBODIMENTS

The technologies disclosed herein may be applicable to wireless power transfer (or wireless power transmission). However, the technologies disclosed herein are not limited to this, and may be also applicable to all kinds of power transmission systems and methods, wireless charging circuits and methods to which the technological spirit of the technology can be applicable, in addition to the methods and apparatuses using power transmitted in a wireless manner.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

In addition, a suffix “module” or “unit” used for constituent elements disclosed in the following description is merely intended for easy description of the specification, and the suffix itself does not give any special meaning or function.

Furthermore, the terms including an ordinal number such as first, second, etc. can be used to describe various elements, but the elements should not be limited by those terms. The terms are used merely for the purpose to distinguish an element from the other element. For example, a first element may be named to a second element, and similarly, a second element may be named to a first element without departing from the scope of right of the invention.

Hereinafter, preferred embodiments of the present invention will be described in detail with reference to the accompanying drawings, and the same or similar elements are designated with the same numeral references regardless of the numerals in the drawings and their redundant description will be omitted.

In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings.

### Definition

Many-to-one communication: communicating between one transmitter (Tx) and many receivers (Rx)

Unidirectional communication: transmitting a required message only from a receiver to a transmitter

Bidirectional communication: allowing message transmission from a transmitter to a receiver and from the receiver to the transmitter, namely, at both sides

Here, the transmitter and the receiver indicate the same as a transmission apparatus (device) and a reception apparatus (device), respectively. Hereinafter, those terms may be used together.

Conceptual View of Wireless Power Transmitter and Wireless Power Receiver

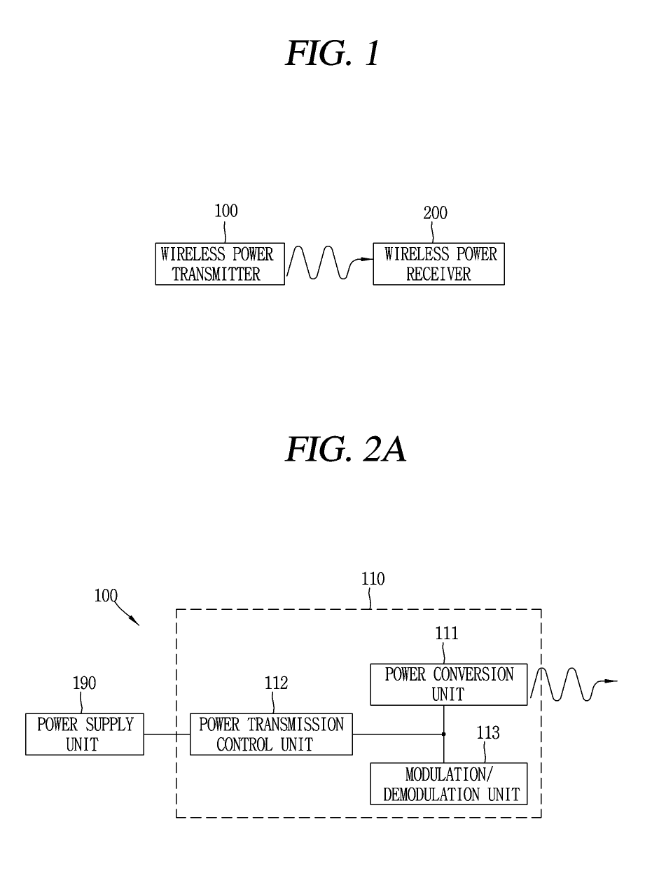

FIG. 1 is an exemplary view conceptually illustrating a wireless power transmitter 100 and a wireless power receiver 200 according to the embodiments of the present invention.

Referring to FIG. 1, a wireless power transmitter 100 may be a power transfer apparatus configured to transfer power required for a wireless power receiver 200 in a wireless manner.

Furthermore, the wireless power transmitter 100 may be a wireless charging apparatus configured to charge a battery of the wireless power receiver 200 by transferring power in a wireless manner.

Additionally, the wireless power transmitter 100 may be implemented with various forms of apparatuses transferring power to the wireless power receiver 200 requiring power in a contactless state.

The wireless power receiver 200 is a device that is operable by receiving power from the wireless power transmitter 100 in a wireless manner. Furthermore, the wireless power receiver 200 may charge a battery using the received wireless power.

On the other hand, the wireless power receiver for receiving power in a wireless manner as described herein should be construed broadly to include a portable phone, a cellular phone, a smart phone, a personal digital assistant (PDA), a portable multimedia player (PMP), a tablet, a multimedia device, or the like, in addition to an input/output device such as a keyboard, a mouse, an audio-visual auxiliary device, and the like.

The wireless power receiver 200, as described later, may be a mobile communication terminal (for example, a portable phone, a cellular phone, a tablet and the like) or a multimedia device.

On the other hand, the wireless power transmitter 100 may transfer power in a wireless manner without mutual contact to the wireless power receiver 200 using one or more wireless power transfer methods. In other words, the wireless power transmitter 100 may transfer power using at least one of an inductive coupling method based on magnetic induction phenomenon by the wireless power signal and a magnetic resonance coupling method based on electromagnetic resonance phenomenon by a wireless power signal at a specific frequency.

Wireless power transfer in the resonance coupling method is a technology transferring power in a wireless manner using a primary coil and a secondary coil, and refers to the transmission of power by inducing a current from a coil to another coil through a changing magnetic field by a magnetic induction phenomenon.

Wireless power transfer in the resonance coupling method refers to a technology in which the wireless power receiver 200 generates resonance by a wireless power signal transmitted from the wireless power transmitter 100 to transfer power from the wireless power transmitter 100 to the wireless power receiver 200 by the resonance phenomenon.

Hereinafter, the wireless power transmitter 100 and wireless power receiver 200 according to the embodiments disclosed herein will be described in detail. In assigning reference numerals to the constituent elements in each of the following drawings, the same reference numerals will be used for the same constituent elements even though they are shown in a different drawing.

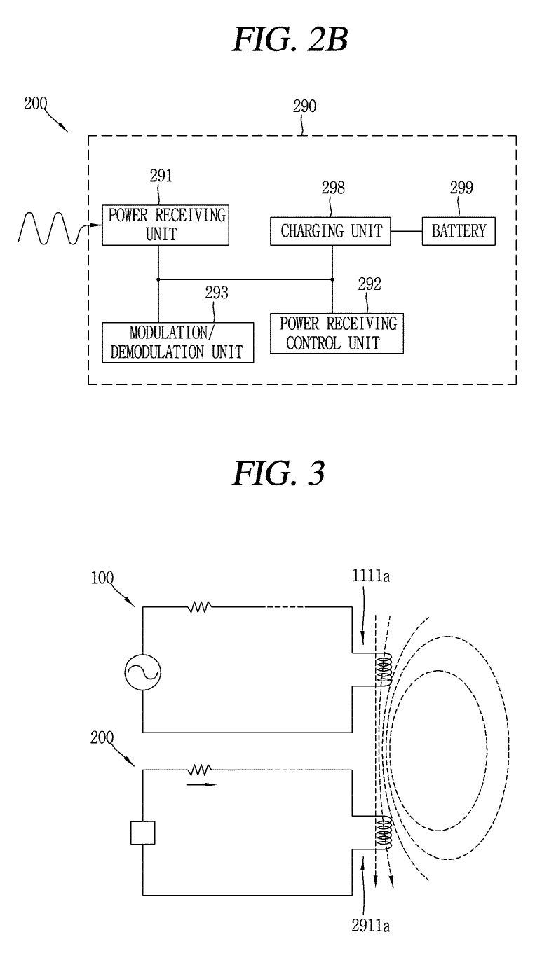

FIGS. 2A and 2B are exemplary block diagrams illustrating the configuration of a wireless power transmitter 100 and a wireless power receiver 200 that can be employed in the embodiments disclosed herein.

Wireless Power Transmitter

Referring to FIG. 2A, the wireless power transmitter 100 may include a power transmission unit 110. The power transmission unit 110 may include a power conversion unit 111 and a power transmission control unit 112.

The power conversion unit 111 transfers power supplied from a transmission side power supply unit 190 to the wireless power receiver 200 by converting it into a wireless power signal. The wireless power signal transferred by the power conversion unit 111 is generated in the form of a magnetic field or electro-magnetic field having an oscillation characteristic. For this purpose, the power conversion unit 111 may be configured to include a coil for generating the wireless power signal.

The power conversion unit 111 may include a constituent element for generating a different type of wireless power signal according to each power transfer method. For example, the power conversion unit 111 may include a primary coil for forming a changing magnetic field to induce a current to a secondary coil of the wireless power receiver 200. Furthermore, the power conversion unit 111 may include a coil (or antenna) for forming a magnetic field having a specific resonant frequency to generate a resonant frequency in the wireless power receiver 200 according to the resonance coupling method.

Furthermore, the power conversion unit 111 may transfer power using at least one of the foregoing inductive coupling method and the resonance coupling method.

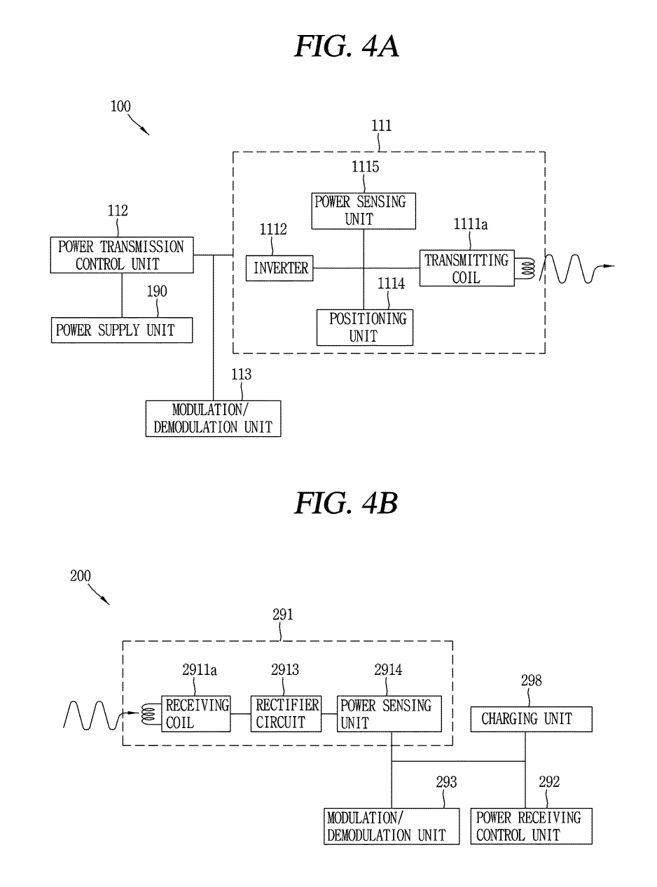

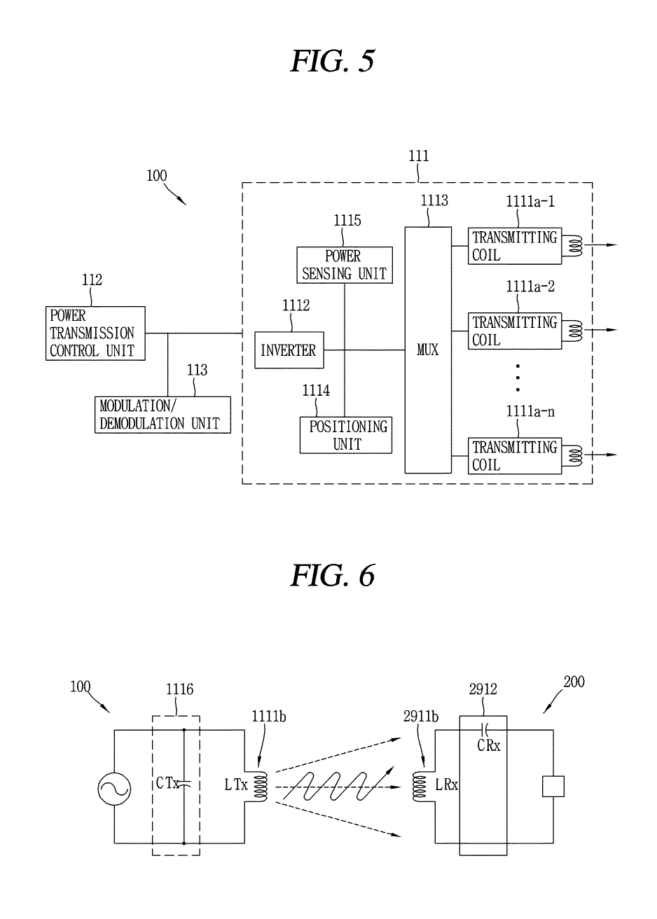

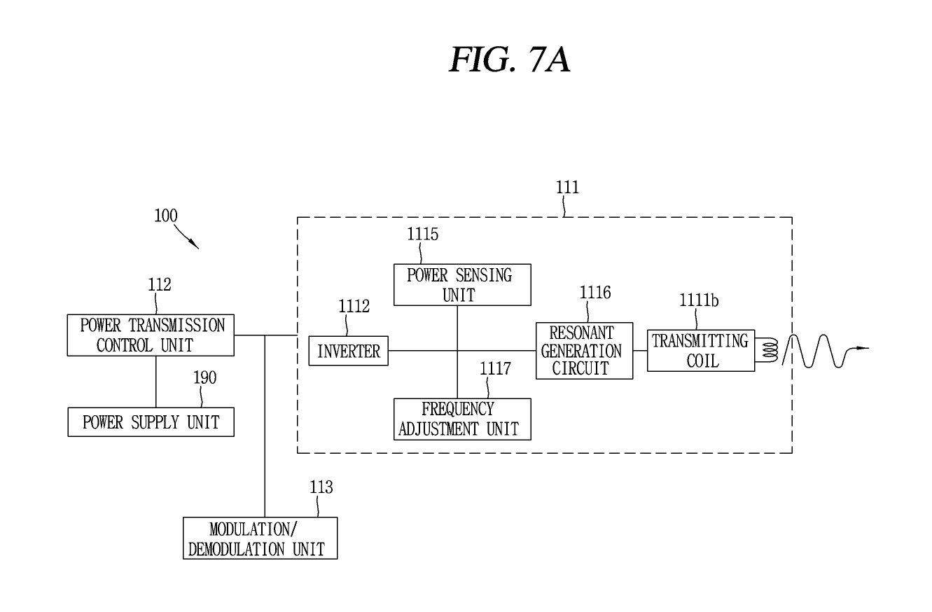

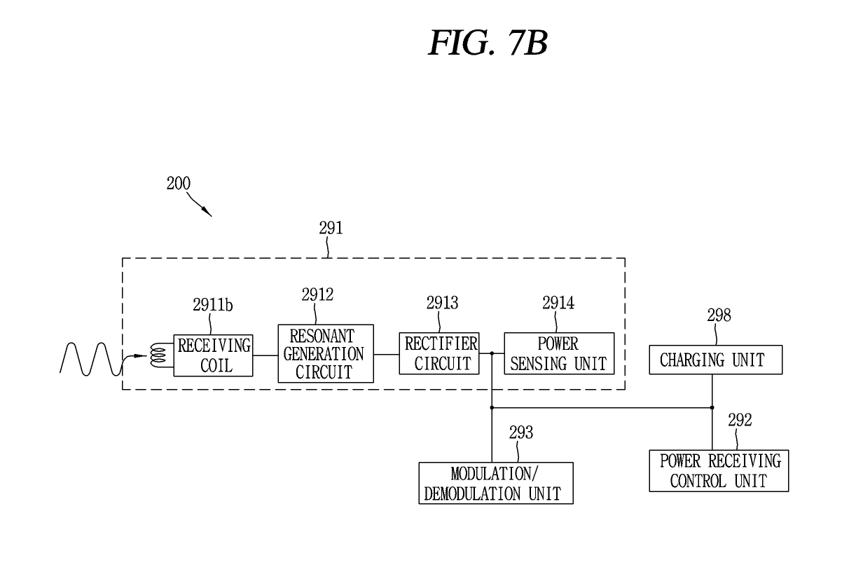

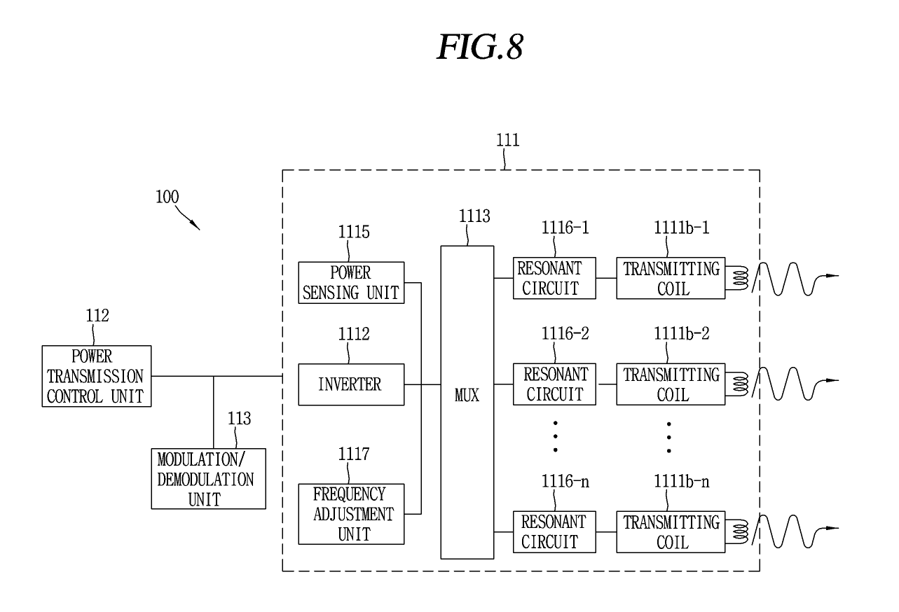

Among the constituent elements included in the power conversion unit 111, those for the inductive coupling method will be described later with reference to FIGS. 4 and 5, and those for the resonance coupling method will be described with reference to FIGS. 7 and 8.

On the other hand, the power conversion unit 111 may further include a circuit for controlling the characteristics of a used frequency, an applied voltage, an applied current or the like to form the wireless power signal.

The power transmission control unit 112 controls each of the constituent elements included in the power transmission unit 110. The power transmission control unit 112 may be implemented to be integrated into another control unit (not shown) for controlling the wireless power transmitter 100.

On the other hand, a region which the wireless power signal can be approached may be divided into two types. First, an active area denotes a region through which a wireless power signal transferring power to the wireless power receiver 200 is passed. Next, a semi-active area denotes an interest region in which the wireless power transmitter 100 can detect the existence of the wireless power receiver 200. Here, the power transmission control unit 112 may detect whether the wireless power receiver 200 is placed in the active area or detection area or removed from the area. Specifically, the power transmission control unit 112 may detect whether or not the wireless power receiver 200 is placed in the active area or detection area using a wireless power signal formed from the power conversion unit 111 or a sensor separately provided therein. For instance, the power transmission control unit 112 may detect the presence of the wireless power receiver 200 by monitoring whether or not the characteristic of power for forming the wireless power signal is changed by the wireless power signal, which is affected by the wireless power receiver 200 existing in the detection area. However, the active area and detection area may vary according to the wireless power transfer method such as an inductive coupling method, a resonance coupling method, and the like.

The power transmission control unit 112 may perform the process of identifying the wireless power receiver 200 or determine whether to start wireless power transfer according to a result of detecting the existence of the wireless power receiver 200.

Furthermore, the power transmission control unit 112 may determine at least one characteristic of a frequency, a voltage, and a current of the power conversion unit 111 for forming the wireless power signal. The determination of the characteristic may be carried out by a condition at the side of the wireless power transmitter 100 or a condition at the side of the wireless power receiver 200.

The power transmission control unit 112 may receive a power control message from the wireless power receiver 200. The power transmission control unit 112 may determine at least one characteristic of a frequency, a voltage and a current of the power conversion unit 111 based on the received power control message, and additionally perform other control operations based on the power control message.

For example, the power transmission control unit 112 may determine at least one characteristic of a frequency, a voltage and a current used to form the wireless power signal according to the power control message including at least one of rectified power amount information, charging state information and identification information in the wireless power receiver 200.

Furthermore, as another control operation using the power control message, the wireless power transmitter 100 may perform a typical control operation associated with wireless power transfer based on the power control message. For example, the wireless power transmitter 100 may receive information associated with the wireless power receiver 200 to be auditorily or visually outputted through the power control message, or receive information required for authentication between devices.

In exemplary embodiments, the power transmission control unit 112 may receive the power control message through the wireless power signal. In other exemplary embodiment, the power transmission control unit 112 may receive the power control message through a method for receiving user data.

In order to receive the foregoing power control message, the wireless power transmitter 100 may further include a modulation/demodulation unit 113 electrically connected to the power conversion unit 111. The modulation/demodulation unit 113 may demodulate a wireless power signal that has been modulated by the wireless power receiver 200 and use it to receive the power control message.

In addition, the power transmission control unit 112 may acquire a power control message by receiving user data including the power control message by a communication means (not shown) included in the wireless power transmitter 100.

[For Supporting in-Band Two-Way Communication]

Under a wireless power transfer environment allowing for bi-directional communications according to the exemplary embodiments disclosed herein, the power transmission control unit 112 may transmit data to the wireless power receiver 200. The data transmitted by the power transmission control unit 112 may be transmitted to request the wireless power receiver 200 to send the power control message.

Wireless Power Receiver

Referring to FIG. 2B, the wireless power receiver 200 may include a power supply unit 290. The power supply unit 290 supplies power required for the operation of the wireless power receiver 200. The power supply unit 290 may include a power receiving unit 291 and a power reception control unit 292.

The power receiving unit 291 receives power transferred from the wireless power transmitter 100 in a wireless manner.

The power receiving unit 291 may include constituent elements required to receive the wireless power signal according to a wireless power transfer method. Furthermore, the power receiving unit 291 may receive power according to at least one wireless power transfer method, and in this case, the power receiving unit 291 may include constituent elements required for each method.

First, the power receiving unit 291 may include a coil for receiving a wireless power signal transferred in the form of a magnetic field or electromagnetic field having a vibration characteristic.

For instance, as a constituent element according to the inductive coupling method, the power receiving unit 291 may include a secondary coil to which a current is induced by a changing magnetic field. In exemplary embodiments, the power receiving unit 291, as a constituent element according to the resonance coupling method, may include a coil and a resonant circuit in which resonance phenomenon is generated by a magnetic field having a specific resonant frequency.

In another exemplary embodiments, when the power receiving unit 291 receives power according to at least one wireless power transfer method, the power receiving unit 291 may be implemented to receive power by using a coil, or implemented to receive power by using a coil formed differently according to each power transfer method.

Among the constituent elements included in the power receiving unit 291, those for the inductive coupling method will be described later with reference to FIG. 4, and those for the resonance coupling method with reference to FIG. 7.

On the other hand, the power receiving unit 291 may further include a rectifier and a regulator to convert the wireless power signal into a direct current. Furthermore, the power receiving unit 291 may further include a circuit for protecting an overvoltage or overcurrent from being generated by the received power signal.

The power reception control unit 292 may control each constituent element included in the power supply unit 290.

Specifically, the power reception control unit 292 may transfer a power control message to the wireless power transmitter 100. The power control message may instruct the wireless power transmitter 100 to initiate or terminate a transfer of the wireless power signal. Furthermore, the power control message may instruct the wireless power transmitter 100 to control a characteristic of the wireless power signal.

In exemplary embodiments, the power reception control unit 292 may transmit the power control message through at least one of the wireless power signal and user data.

In order to transmit the foregoing power control message, the wireless power receiver 200 may further include a modulation/demodulation unit 293 electrically connected to the power receiving unit 291. The modulation/demodulation unit 293, similarly to the case of the wireless power transmitter 100, may be used to transmit the power control message through the wireless power signal. The power communications modulation/demodulation unit 293 may be used as a means for controlling a current and/or voltage flowing through the power conversion unit 111 of the wireless power transmitter 100. Hereinafter, a method for allowing the power communications modulation/demodulation unit 113 or 293 at the side of the wireless power transmitter 100 and at the side of the wireless power receiver 200, respectively, to be used to transmit and receive a power control message through a wireless power signal will be described.

A wireless power signal formed by the power conversion unit 111 is received by the power receiving unit 291. At this time, the power reception control unit 292 controls the power communications modulation/demodulation unit 293 at the side of the wireless power receiver 200 to modulate the wireless power signal. For instance, the power reception control unit 292 may perform a modulation process such that a power amount received from the wireless power signal is varied by changing a reactance of the power communications modulation/demodulation unit 293 connected to the power receiving unit 291. The change of a power amount received from the wireless power signal results in the change of a current and/or voltage of the power conversion unit 111 for forming the wireless power signal. At this time, the modulation/demodulation unit 113 at the side of the wireless power transmitter 100 may detect a change of the current and/or voltage to perform a demodulation process.

In other words, the power reception control unit 292 may generate a packet including a power control message intended to be transferred to the wireless power transmitter 100 and modulate the wireless power signal to allow the packet to be included therein, and the power transmission control unit 112 may decode the packet based on a result of performing the demodulation process of the power communications modulation/demodulation unit 113 to acquire the power control message included in the packet.

In addition, the power reception control unit 292 may transmit a power control message to the wireless power transmitter 100 by transmitting user data including the power control message by a communication means (not shown) included in the wireless power receiver 200.

[For Supporting in-Band Two-Way Communication]

Under a wireless power transfer environment allowing for bi-directional communications according to the exemplary embodiments disclosed herein, the power reception control unit 292 may receive data to the wireless power transmitter 100. The data transmitted by the wireless power transmitter 100 may be transmitted to request the wireless power receiver 200 to send the power control message.

In addition, the power supply unit 290 may further include a charger 298 and a battery 299.

The wireless power receiver 200 receiving power for operation from the power supply unit 290 may be operated by power transferred from the wireless power transmitter 100, or operated by charging the battery 299 using the transferred power and then receiving the charged power. At this time, the power reception control unit 292 may control the charger 298 to perform charging using the transferred power.

Hereinafter, description will be given of a wireless power transmitter and a wireless power receiver applicable to the exemplary embodiments disclosed herein. First, a method of allowing the wireless power transmitter to transfer power to the wireless power receiver according to the inductive coupling method will be described with reference to FIGS. 3 through 5.

Inductive Coupling Method

FIG. 3 is a view illustrating a concept in which power is transferred from a wireless power transmitter to a wireless receiver in a wireless manner according to an inductive coupling method.

When the power of the wireless power transmitter 100 is transferred in an inductive coupling method, if the strength of a current flowing through a primary coil within the power transmission unit 110 is changed, then a magnetic field passing through the primary coil will be changed by the current. The changed magnetic field generates an induced electromotive force at a secondary coil in the wireless power receiver 200.

According to the foregoing method, the power conversion unit 111 of the wireless power transmitter 100 may include a transmitting (Tx) coil 1111a being operated as a primary coil in magnetic induction. Furthermore, the power receiving unit 291 of the wireless power receiver 200 may include a receiving (Rx) coil 2911a being operated as a secondary coil in magnetic induction.

First, the wireless power transmitter 100 and wireless power receiver 200 are disposed in such a manner that the transmitting coil 1111a at the side of the wireless power transmitter 100 and the receiving coil at the side of the wireless power receiver 200 are located adjacent to each other. Then, if the power transmission control unit 112 controls a current of the transmitting coil (Tx coil) 1111a to be changed, then the power receiving unit 291 controls power to be supplied to the wireless power receiver 200 using an electromotive force induced to the receiving coil (Rx coil) 2911a.

The efficiency of wireless power transfer by the inductive coupling method may be little affected by a frequency characteristic, but affected by an alignment and distance between the wireless power transmitter 100 and the wireless power receiver 200 including each coil.

On the other hand, in order to perform wireless power transfer in the resonance coupling method, the wireless power transmitter 100 may be configured to include an interface surface (not shown) in the form of a flat surface. One or more wireless power receivers may be placed at an upper portion of the interface surface, and the transmitting coil 1111a may be mounted at a lower portion of the interface surface. In this case, a vertical spacing is formed in a small-scale between the transmitting coil 1111a mounted at a lower portion of the interface surface and the receiving coil 2911a of the wireless power receiver 200 placed at an upper portion of the interface surface, and thus a distance between the coils becomes sufficiently small to efficiently implement contactless power transfer by the inductive coupling method.

Furthermore, an alignment indicator (not shown) indicating a location where the wireless power receiver 200 is to be placed at an upper portion of the interface surface. The alignment indicator indicates a location of the wireless power receiver 200 where an alignment between the transmitting coil 1111a mounted at a lower portion of the interface surface and the receiving coil 2911a can be suitably implemented. The alignment indicator may alternatively be simple marks, or may be formed in the form of a protrusion structure for guiding the location of the wireless power receiver 200. Otherwise, the alignment indicator may be formed in the form of a magnetic material such as a magnet mounted at a lower portion of the interface surface, thereby guiding the coils to be suitably arranged by mutual magnetism to a magnetic material having an opposite polarity mounted within the wireless power receiver 200.

On the other hand, the wireless power transmitter 100 may be formed to include one or more transmitting coils. The wireless power transmitter 100 may selectively use some of coils suitably arranged with the receiving coil 2911a of the wireless power receiver 200 among the one or more transmitting coils to enhance the power transmission efficiency. The wireless power transmitter 100 including the one or more transmitting coils will be described later with reference to FIG. 5.

Hereinafter, configurations of the wireless power transmitter and wireless power receiver using an inductive coupling method applicable to the embodiments disclosed herein will be described in detail.

Wireless Power Transmitter and Wireless Power Receiver in Inductive Coupling Method

FIG. 4 is a block diagram illustrating partial configurations of the wireless power transmitter 100 and wireless power receiver 200 in a magnetic induction method that can be employed in the embodiments disclosed herein. A configuration of the power transmission unit 110 included in the wireless power transmitter 100 will be described with reference to FIG. 4A, and a configuration of the power supply unit 290 included in the wireless power receiver 200 will be described with reference to FIG. 4B.

Referring to FIG. 4A, the power conversion unit 111 of the wireless power transmitter 100 may include a transmitting (Tx) coil 1111a and an inverter 1112.

The transmitting coil 1111a may form a magnetic field corresponding to the wireless power signal according to a change of current as described above. The transmitting coil 1111a may alternatively be implemented with a planar spiral type or cylindrical solenoid type.

The inverter 1112 transforms a DC input obtained from the power supply unit 190 into an AC waveform. The AC current transformed by the inverter 1112 drives a resonant circuit including the transmitting coil 1111a and a capacitor (not shown) to form a magnetic field in the transmitting coil 1111a.

In addition, the power conversion unit 111 may further include a positioning unit 1114.

The positioning unit 1114 may move or rotate the transmitting coil 1111a to enhance the effectiveness of contactless power transfer using the inductive coupling method. As described above, it is because an alignment and distance between the wireless power transmitter 100 and the wireless power receiver 200 including a primary coil and a secondary coil may affect power transfer using the inductive coupling method. In particular, the positioning unit 1114 may be used when the wireless power receiver 200 does not exist within an active area of the wireless power transmitter 100.

Accordingly, the positioning unit 1114 may include a drive unit (not shown) for moving the transmitting coil 1111a such that a center-to-center distance of the transmitting coil 1111a of the wireless power transmitter 100 and the receiving coil 2911a of the wireless power receiver 200 is within a predetermined range, or rotating the transmitting coil 1111a such that the centers of the transmitting coil 1111a and the receiving coil 2911a are overlapped with each other.

For this purpose, the wireless power transmitter 100 may further include a detection unit (not shown) made of a sensor for detecting the location of the wireless power receiver 200, and the power transmission control unit 112 may control the positioning unit 1114 based on the location information of the wireless power receiver 200 received from the location detection sensor.

Furthermore, to this end, the power transmission control unit 112 may receive control information on an alignment or distance to the wireless power receiver 200 through the power communications modulation/demodulation unit 113, and control the positioning unit 1114 based on the received control information on the alignment or distance.

If the power conversion unit 111 is configured to include a plurality of transmitting coils, then the positioning unit 1114 may determine which one of the plurality of transmitting coils is to be used for power transmission. The configuration of the wireless power transmitter 100 including the plurality of transmitting coils will be described later with reference to FIG. 5.

On the other hand, the power conversion unit 111 may further include a power sensing unit 1115. The power sensing unit 1115 at the side of the wireless power transmitter 100 monitors a current or voltage flowing into the transmitting coil 1111a. The power sensing unit 1115 is provided to check whether or not the wireless power transmitter 100 is normally operated, and thus the power sensing unit 1115 may detect a voltage or current of the power supplied from the outside, and check whether the detected voltage or current exceeds a threshold value. The power sensing unit 1115, although not shown, may include a resistor for detecting a voltage or current of the power supplied from the outside and a comparator for comparing a voltage value or current value of the detected power with a threshold value to output the comparison result. Based on the check result of the power sensing unit 1115, the power transmission control unit 112 may control a switching unit (not shown) to cut off power applied to the transmitting coil 1111a.

Referring to FIG. 4B, the power supply unit 290 of the wireless power receiver 200 may include a receiving (Rx) coil 2911a and a rectifier 2913.

A current is induced into the receiving coil 2911a by a change of the magnetic field formed in the transmitting coil 1111a. The implementation type of the receiving coil 2911a may be a planar spiral type or cylindrical solenoid type similarly to the transmitting coil 1111a.

Furthermore, series and parallel capacitors may be configured to be connected to the receiving coil 2911a to enhance the effectiveness of wireless power reception or perform resonant detection.

The receiving coil 2911a may be in the form of a single coil or a plurality of coils.

The rectifier 2913 performs a full-wave rectification to a current to convert alternating current into direct current. The rectifier 2913, for instance, may be implemented with a full-bridge rectifier made of four diodes or a circuit using active components.

In addition, the rectifier 2913 may further include a regulator for converting a rectified current into a more flat and stable direct current. Furthermore, the output power of the rectifier 2913 is supplied to each constituent element of the power supply unit 290. Furthermore, the rectifier 2913 may further include a DC-DC converter for converting output DC power into a suitable voltage to adjust it to the power required for each constituent element (for instance, a circuit such as a charger 298).

The power communications modulation/demodulation unit 293 may be connected to the power receiving unit 291, and may be configured with a resistive element in which resistance varies with respect to direct current, and may be configured with a capacitive element in which reactance varies with respect to alternating current. The power reception control unit 292 may change the resistance or reactance of the power communications modulation/demodulation unit 293 to modulate a wireless power signal received to the power receiving unit 291.

On the other hand, the power supply unit 290 may further include a power sensing unit 2914. The power sensing unit 2914 at the side of the wireless power receiver 200 monitors a voltage and/or current of the power rectified by the rectifier 2913, and if the voltage and/or current of the rectified power exceeds a threshold value as a result of monitoring, then the power reception control unit 292 transmits a power control message to the wireless power transmitter 100 to transfer suitable power.

Wireless Power Transmitter Configured to Include One or More Transmitting Coils

FIG. 5 is a block diagram illustrating a wireless power transmitter configured to have one or more transmitting coils receiving power according to an inductive coupling method that can be employed in the embodiments disclosed herein.

Referring to FIG. 5, the power conversion unit 111 of the wireless power transmitter 100 according to the embodiments disclosed herein may include one or more transmitting coils 1111a-1 to 1111a-n. The one or more transmitting coils 1111a-1 to 1111a-n may be an array of partly overlapping primary coils. An active area may be determined by some of the one or more transmitting coils.

The one or more transmitting coils 1111a-1 to 1111a-n may be mounted at a lower portion of the interface surface. Furthermore, the power conversion unit 111 may further include a multiplexer 1113 for establishing and releasing the connection of some of the one or more transmitting coils 1111a-1 to 1111a-n.

Upon detecting the location of the wireless power receiver 200 placed at an upper portion of the interface surface, the power transmission control unit 112 may take the detected location of the wireless power receiver 200 into consideration to control the multiplexer 1113, thereby allowing coils that can be placed in an inductive coupling relation to the receiving coil 2911a of the wireless power receiver 200 among the one or more transmitting coils 1111a-1 to 1111a-n to be connected to one another.

For this purpose, the power transmission control unit 112 may acquire the location information of the wireless power receiver 200. For example, the power transmission control unit 112 may acquire the location of the wireless power receiver 200 on the interface surface by the location detection unit (not shown) provided in the wireless power transmitter 100. For another example, the power transmission control unit 112 may alternatively receive a power control message indicating a strength of the wireless power signal from an object on the interface surface or a power control message indicating the identification information of the object using the one or more transmitting coils 1111a-1 to 1111a-n, respectively, and determines whether it is located adjacent to which one of the one or more transmitting coils based on the received result, thereby acquiring the location information of the wireless power receiver 200.

On the other hand, the active area as part of the interface surface may denote a portion through which a magnetic field with a high efficiency can pass when the wireless power transmitter 100 transfers power to the wireless power receiver 200 in a wireless manner. At this time, a single transmitting coil or a combination of one or more transmitting coils forming a magnetic field passing through the active area may be designated as a primary cell. Accordingly, the power transmission control unit 112 may determine an active area based on the detected location of the wireless power receiver 200, and establish the connection of a primary cell corresponding to the active area to control the multiplexer 1113, thereby allowing the receiving coil 2911a of the wireless power receiver 200 and the coils belonging to the primary cell to be placed in an inductive coupling relation.

Furthermore, the power conversion unit 111 may further include an impedance matching unit (not shown) for controlling an impedance to form a resonant circuit with the coils connected thereto.

Hereinafter, a method for allowing a wireless power transmitter to transfer power according to a resonance coupling method will be disclosed with reference to FIGS. 6 through 8.

Resonance Coupling Method

FIG. 6 is a view illustrating a concept in which power is transferred to a wireless power receiver from a wireless power transmitter in a wireless manner according to a resonance coupling method.

First, resonance will be described in brief as follows. Resonance refers to a phenomenon in which amplitude of vibration is remarkably increased when periodically receiving an external force having the same frequency as the natural frequency of a vibration system. Resonance is a phenomenon occurring at all kinds of vibrations such as mechanical vibration, electric vibration, and the like. Generally, when exerting a vibratory force to a vibration system from the outside, if the natural frequency thereof is the same as a frequency of the externally applied force, then the vibration becomes strong, thus increasing the width.

With the same principle, when a plurality of vibrating bodies separated from one another within a predetermined distance vibrate at the same frequency, the plurality of vibrating bodies resonate with one another, and in this case, resulting in a reduced resistance between the plurality of vibrating bodies. In an electrical circuit, a resonant circuit can be made by using an inductor and a capacitor.

When the wireless power transmitter 100 transfers power according to the inductive coupling method, a magnetic field having a specific vibration frequency is formed by alternating current power in the power transmission unit 110. If a resonance phenomenon occurs in the wireless power receiver 200 by the formed magnetic field, then power is generated by the resonance phenomenon in the wireless power receiver 200.

The resonant frequency may be determined by the following formula in Equation 1.

$$f = \frac{1}{2 π \sqrt{LC}} \qquad [ Equation 1 ]$$

Here, the resonant frequency (f) is determined by an inductance (L) and a capacitance (C) in a circuit. In a circuit forming a magnetic field using a coil, the inductance can be determined by a number of turns of the coil, and the like, and the capacitance can be determined by a gap between the coils, an area, and the like. In addition to the coil, a capacitive resonant circuit may be configured to be connected thereto to determine the resonant frequency.

Referring to FIG. 6, when power is transmitted in a wireless manner according to the resonance coupling method, the power conversion unit 111 of the wireless power transmitter 100 may include a transmitting (Tx) coil 1111b in which a magnetic field is formed and a resonant circuit 1116 connected to the transmitting coil 1111b to determine a specific vibration frequency. The resonant circuit 1116 may be implemented by using a capacitive circuit (capacitors), and the specific vibration frequency may be determined based on an inductance of the transmitting coil 1111b and a capacitance of the resonant circuit 1116.

The configuration of a circuit element of the resonant circuit 1116 may be implemented in various forms such that the power conversion unit 111 forms a magnetic field, and is not limited to a form of being connected in parallel to the transmitting coil 1111b as illustrated in FIG. 6.

Furthermore, the power receiving unit 291 of the wireless power receiver 200 may include a resonant circuit 2912 and a receiving (Rx) coil 2911b to generate a resonance phenomenon by a magnetic field formed in the wireless power transmitter 100. In other words, the resonant circuit 2912 may be also implemented by using a capacitive circuit, and the resonant circuit 2912 is configured such that a resonant frequency determined based on an inductance of the receiving coil 2911b and a capacitance of the resonant circuit 2912 has the same frequency as a resonant frequency of the formed magnetic field.

The configuration of a circuit element of the resonant circuit 2912 may be implemented in various forms such that the power receiving unit 291 generates resonance by a magnetic field, and is not limited to a form of being connected in series to the receiving coil 2911b as illustrated in FIG. 6.

The specific vibration frequency in the wireless power transmitter 100 may have LTX, CTX, and may be acquired by using the Equation 1. Here, the wireless power receiver 200 generates resonance when a result of substituting the LRX and CRX of the wireless power receiver 200 to the Equation 1 is same as the specific vibration frequency.

According to a contactless power transfer method by resonance coupling, when the wireless power transmitter 100 and wireless power receiver 200 resonate at the same frequency, respectively, an electromagnetic wave is propagated through a short-range magnetic field, and thus there exists no energy transfer between the devices if they have different frequencies.

As a result, an efficiency of contactless power transfer by the resonance coupling method is greatly affected by a frequency characteristic, whereas the effect of an alignment and distance between the wireless power transmitter 100 and the wireless power receiver 200 including each coil is relatively smaller than the inductive coupling method.

Hereinafter, the configuration of a wireless power transmitter and a wireless power receiver in the resonance coupling method applicable to the embodiments disclosed herein will be described in detail.

Wireless Power Transmitter in Resonance Coupling Method

FIG. 7 is a block diagram illustrating part of the wireless power transmitter 100 and wireless power receiver 200 in a resonance method that can be employed in the embodiments disclosed herein.

A configuration of the power transmission unit 110 included in the wireless power transmitter 100 will be described with reference to FIG. 7A.

The power conversion unit 111 of the wireless power transmitter 100 may include a transmitting (Tx) coil 1111b, an inverter 1112, and a resonant circuit 1116. The inverter 1112 may be configured to be connected to the transmitting coil 1111b and the resonant circuit 1116.

The transmitting coil 1111b may be mounted separately from the transmitting coil 1111a for transferring power according to the inductive coupling method, but may transfer power in the inductive coupling method and resonance coupling method using one single coil.

The transmitting coil 1111b, as described above, forms a magnetic field for transferring power. The transmitting coil 1111b and the resonant circuit 1116 generate resonance when alternating current power is applied thereto, and at this time, a vibration frequency may be determined based on an inductance of the transmitting coil 1111b and a capacitance of the resonant circuit 1116.

For this purpose, the inverter 1112 transforms a DC input obtained from the power supply unit 190 into an AC waveform, and the transformed AC current is applied to the transmitting coil 1111b and the resonant circuit 1116.

In addition, the power conversion unit 111 may further include a frequency adjustment unit 1117 for changing a resonant frequency of the power conversion unit 111. The resonant frequency of the power conversion unit 111 is determined based on an inductance and/or capacitance within a circuit constituting the power conversion unit 111 by Equation 1, and thus the power transmission control unit 112 may determine the resonant frequency of the power conversion unit 111 by controlling the frequency adjustment unit 1117 to change the inductance and/or capacitance.

The frequency adjustment unit 1117, for example, may be configured to include a motor for adjusting a distance between capacitors included in the resonant circuit 1116 to change a capacitance, or include a motor for adjusting a number of turns or diameter of the transmitting coil 1111b to change an inductance, or include active elements for determining the capacitance and/or inductance

On the other hand, the power conversion unit 111 may further include a power sensing unit 1115. The operation of the power sensing unit 1115 is the same as the foregoing description.

Referring to FIG. 7B, a configuration of the power supply unit 290 included in the wireless power receiver 200 will be described. The power supply unit 290, as described above, may include the receiving (Rx) coil 2911b and resonant circuit 2912.

In addition, the power receiving unit 291 of the power supply unit 290 may further include a rectifier 2913 for converting an AC current generated by resonance phenomenon into DC. The rectifier 2913 may be configured similarly to the foregoing description.

Furthermore, the power receiving unit 291 may further include a power sensing unit 2914 for monitoring a voltage and/or current of the rectified power. The power sensing unit 2914 may be configured similarly to the foregoing description.

Wireless Power Transmitter Configured to Include One or More Transmitting Coils

FIG. 8 is a block diagram illustrating a wireless power transmitter configured to have one or more transmitting coils receiving power according to a resonance coupling method that can be employed in the embodiments disclosed herein.

Referring to FIG. 8, the power conversion unit 111 of the wireless power transmitter 100 according to the embodiments disclosed herein may include one or more transmitting coils 1111b-1 to 1111b-n and resonant circuits (1116-1 to 1116-n) connected to each transmitting coils. Furthermore, the power conversion unit 111 may further include a multiplexer 1113 for establishing and releasing the connection of some of the one or more transmitting coils 1111b-1 to 1111b-n.

The one or more transmitting coils 1111b-1 to 1111b-n may be configured to have the same vibration frequency, or some of them may be configured to have different vibration frequencies. It is determined by an inductance and/or capacitance of the resonant circuits (1116-1 to 1116-n) connected to the one or more transmitting coils 1111b-1 to 1111b-n, respectively.

For this purpose, the frequency adjustment unit 1117 may be configured to change an inductance and/or capacitance of the resonant circuits (1116-1 to 1116-n) connected to the one or more transmitting coils 1111b-1 to 1111b-n, respectively.

As described above, the wireless power transmitter (or the wireless power transmission apparatus) according to the present invention can receive data stored in the wireless power receiver (or the wireless power reception apparatus) in addition to transmitting wireless power to the wireless power reception apparatus. More specifically, the wireless power transmission apparatus according to the present invention can receive data from the wireless power reception apparatus and store the received data in a memory provided in the wireless power transmission apparatus. Thus, a backup function for data stored in the wireless power reception apparatus can be provided. In this case, the wireless power transmission apparatus may perform the transmission of the wireless power and simultaneously play a role of an external memory or an external hard disk drive (or an external hard disk).

Here, the wireless power reception apparatus may be a mobile terminal and the mobile terminal may include a mobile phone, a smart phone, a personal digital assistant (PDA), a portable multimedia player (PMP), a navigator, a slate PC, a tablet PC, an ultrabook, a wearable device (e.g., a smart watch, a smart glass, and a head mounted display (HMD)) or the like.

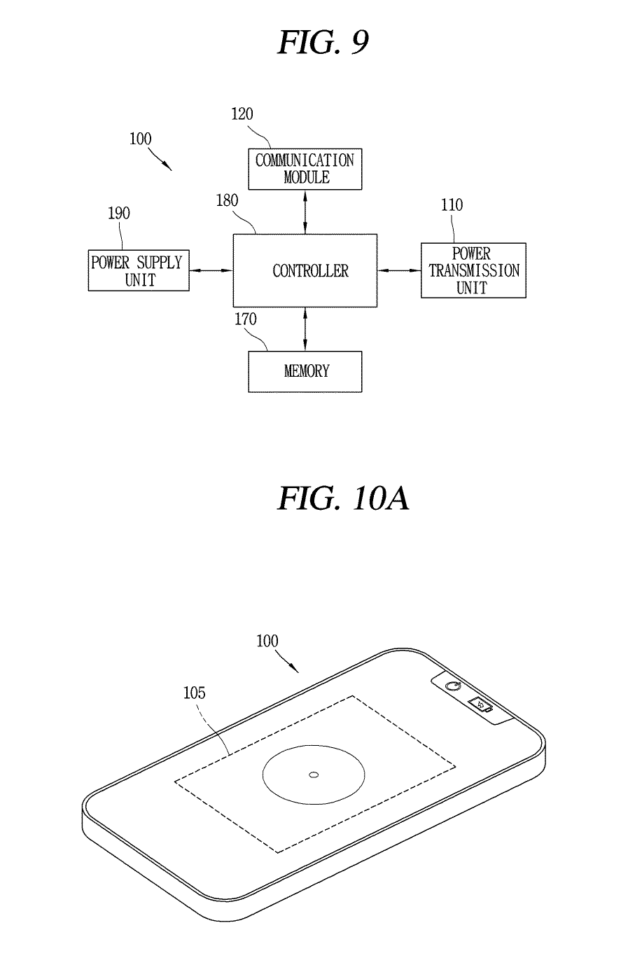

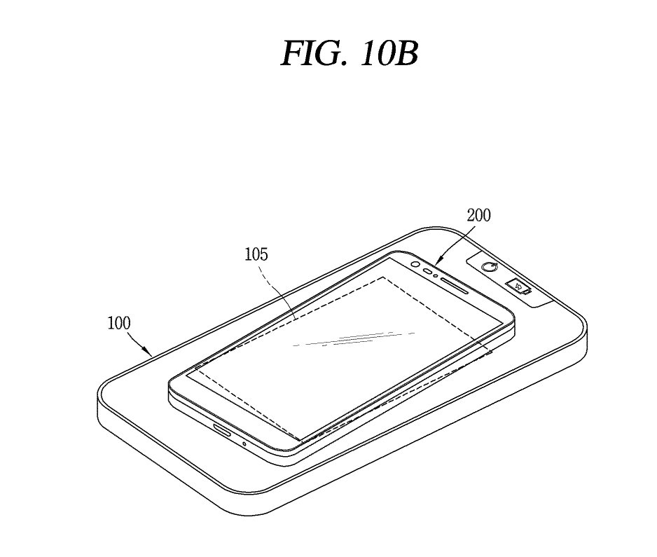

Hereinafter, a wireless power transmission apparatus providing a data backup function will be described in more detail with reference to the accompanying drawings. FIG. 9 is a block diagram illustrating a wireless power transmission apparatus according to the present invention, and FIGS. 10A and 10B are conceptual views illustrating a wireless power transmission apparatus according to the present invention.

As illustrated in FIG. 9, the wireless power transmission apparatus 100 according to the present invention may include a power transmission unit 110, a communication module 120, a memory 170, a controller 180 and a power supply unit 190.

The communication module 120 may include one or more modules that enable wireless communication between the wireless power transmission apparatus 100 and the wireless power reception apparatus 200.

Further, the communication module 120 may include a wireless Internet module and a short-range communication module.

The wireless Internet module is configured to transmit and receive wireless signals on a communication network according to wireless Internet technologies. Examples of the wireless Internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), and the like. In the present invention, the wireless Internet module 113 transmits and receives data according to at least one wireless Internet technology in a range including even Internet technologies which are not listed above.

The wireless power transmission apparatus according to the present invention may receive data to be backed up (i.e., backup target data) from the wireless power reception apparatus through the wireless Internet module of the communication module 120.

The short-range communication module is a module supporting short-range communication. The short-range communication module may support the short-range communication by using at least one technology of Bluetooth™, Radio Frequency Identification (RFID), Infrared Data Association (IrDA), Ultra Wideband (UWB), ZigBee, NFC Communication, Wi-Fi, Wi-Fi direct, and Wireless Universal Serial Bus (USB). The short-range communication module may support wireless communication with the wireless power reception apparatus 200 through short-range wireless area networks. The short-range wireless area networks may be short-range wireless personal area networks.

The wireless power transmission apparatus according to the present invention may transmit and receive data for authentication with the wireless power reception apparatus through the short-range communication module of the communication module 120, in order to perform a data backup function for the wireless power reception apparatus.

In addition, the memory 170 stores data that supports various functions of the wireless power transmission apparatus 100. The memory 170 may store an application program (or application) operated in the wireless power transmission apparatus 100, and data and command words for operations of the wireless power transmission apparatus 100.

Meanwhile, the application program may be stored in the memory 170 and installed on the wireless power transmission apparatus 100 so as to be operated, such that a function according to the application program can be executed by the controller 180. Here, the application program may be an application program for supporting the data backup function.

Further, the memory 170 may include at least one storage medium of a flash memory type, a hard disk type, a Solid State Disk (SSD) type, a Silicon Disk Drive type (SDD) type, a multimedia card type Micro type, a card type memory (e.g., SD or XD memory), a Random Access Memory (RAM), a Static Random Access Memory (SRAM), a Read-Only Memory (ROM), an Electrically Erasable Programmable Read-Only Memory (PROM), a Programmable Read-Only Memory (PROM), a magnetic memory, a magnetic disk, and an optical disk. The wireless power transmission apparatus 100 may operate in association with a web storage that performs the storage function of the memory 170 on the Internet.

Data received from the wireless power reception apparatus through the data backup function may be stored in the memory 170.

In addition to the operation related to the application program stored in the memory 170, the controller 180 typically controls overall operations of the wireless power transmission apparatus 100. The controller 180 may process signals, data, information, etc., input or output through the above-mentioned components or may operate the application program stored in the memory 170 to provide or process assorted information or function to a user.

The controller 180 may control at least some of the components included in the wireless power transmission apparatus 100, in order to operate the application program stored in the memory 170. In addition, the controller 180 may operate at least two of the components included in the wireless power transmission apparatus 100 in a combining manner, in order to operate the application program.

The configuration of the power transmission unit 110 and the power supply unit 190 illustrated in FIG. 9 will be understood by the description previously described with reference to FIGS. 1 to 8.

As described above, the wireless power transmission apparatus 100 according to the present invention can perform the data backup function as well as the wireless power transmission function, by further including the communication module 120 and the memory 170 for performing the data backup function, in addition to the power transmission unit 110 and the power supply unit 190 for supplying wireless power.

Furthermore, the wireless power transmission apparatus according to the present invention can receive data stored in the wireless power reception apparatus through the wireless Internet module for large volume data transmission and high-speed data transmission.

Meanwhile, the wireless power transmission apparatus 100 according to the present invention may detect through the short-range communication module that the wireless power reception apparatus is located on a wireless charging area 105 illustrated in FIGS. 10A and 10B. Here, the wireless charging area 105 may include at least one of the aforementioned active area and semi-active area.

Here, the active area refers to a region or area through which a wireless power signal for transmitting power to the wireless power reception apparatus 200 passes. The semi-active area refers to a region of interest in which the wireless power transmission apparatus 100 can detect the presence of the wireless power reception apparatus 200.

The controller 180 may detect whether or not the wireless power reception apparatus 200 is arranged on the wireless charging area, by using a wireless power signal generated in the power conversion unit 111 or by using a separately provided sensor or communication module, under the control of the power transmission control unit 112.

The detection for whether or not the wireless power reception apparatus 200 is arranged on the wireless charging area 105 (see FIGS. 10A and 10B) by using the communication module, more specifically, may be executed by a short-range communication module, for example, NFC Field Communication (NFC) communication module.

When whether or not the wireless power transmission apparatus 200 is arranged on the wireless charging area 105 is detected through the NFC communication module, the controller 180 may execute at least one of i) a wireless charging function and ii) a data backup function. i) The wireless charging function has been described in detail with reference to FIGS. 1 to 8. Hereinafter, ii) the data backup function will be mainly described.

The controller 180 may detect that the wireless power reception apparatus 200 is arranged on the wireless charging area 105 through the short-range communication module. In this case, an arranged position of the short-range communication module may correspond to the wireless charging area 105. The short-range communication module may be disposed under the wireless charging area 105.

As such, when the arrangement of the wireless power reception apparatus 200 is detected, the controller 180 may execute the data backup function using authentication information stored in the memory 170.

Here, the authentication information for the data backup function refers to information which is needed by a communication module (e.g., wireless Internet module or Wi-Fi module), which is to be used for receiving data stored in the wireless power reception apparatus 200 upon performing the data backup function, to perform communication with the wireless power reception apparatus 200.

Here, the authentication information may include at least one of Service Set Identifier (SSID) information, access security method information, and password information related to the wireless Internet module.

That is, in order to communicate with the wireless Internet module of the wireless power transmission apparatus 100 according to the present invention, the wireless power reception apparatus 200 may require for at least one of the SSID information, the access security method information, and the password information related to the wireless Internet module.

Furthermore, the authentication information may further include a control message for causing a wireless Internet module of the wireless power reception apparatus to be activated.

As such, the wireless power transmission apparatus 100 according to the present invention can assist the data backup function by transmitting the authentication information to the wireless power reception apparatus 200 through the short-range wireless communication module.

Meanwhile, the wireless power reception apparatus 200 may receive the authentication information to perform at least one operation for performing communication with the wireless Internet module.

As an example, the wireless power reception apparatus 200 may access the wireless Internet module using the authentication information. As another example, the wireless power reception apparatus 200 may switch the wireless Internet module from an inactive state to an active state, in response to the reception of the authentication information, when the wireless Internet module (e.g., Wi-Fi module) for communicating with the wireless power transmission apparatus 100 is in the inactive state. Of course, the wireless power reception apparatus 200 should be provided with a communication module corresponding to the communication module included in the present invention in order to perform the data backup function with the wireless power transmission apparatus 100 according to the present invention.

On the other hand, in the wireless power transmission apparatus 100 according to the present invention, the wireless Internet module for receiving data to be backed up (i.e., backup target data) may always be in an active state. Alternatively, in the wireless power transmission apparatus 100 according to the present invention, while the wireless Internet module for receiving the backup target data is in an inactive state, when the arrangement of the wireless power reception apparatus 200 on the wireless charging area 105 is detected, the wireless Internet module may be switched to the active state. The controller 180 may activate the wireless Internet module when it is detected through the short-range communication module that the wireless power reception apparatus 200 is arranged on the wireless charging area 105.

Meanwhile, the short-range communication module may be an NFC communication module or may exist in a form of an NFC tag. In this case, the aforementioned authentication information may be stored in the NFC tag. When the wireless power reception apparatus 200 is placed on the wireless charging area 105 for wireless charging, the NFC tag may allow the authentication information to be transmitted to the wireless power reception apparatus 200.

Meanwhile, the short-range communication module of the wireless power reception apparatus 200 may perform a function of a reader that is provided in the wireless power transmission apparatus to read out information stored in the NFC tag.

On the other hand, the NFC tag may be configured as at least one of a tag, a sticker or a card with a built-in microchip.

Further, a magnetic material such as a magnet may be provided under the wireless charging area. Accordingly, the wireless power transmission apparatus 100 according to the present invention may guide the wireless power reception apparatus 200 to be placed on the wireless charging area by mutual attractive force with a magnetic material which is provided in the wireless power reception apparatus 200 and has a different polarity.

Further, the magnetic material of the wireless power transmission apparatus 100 may guide the coils to be appropriately arranged by the mutual attractive force with the magnetic material having the different polarity, provided in the wireless power reception apparatus 200.

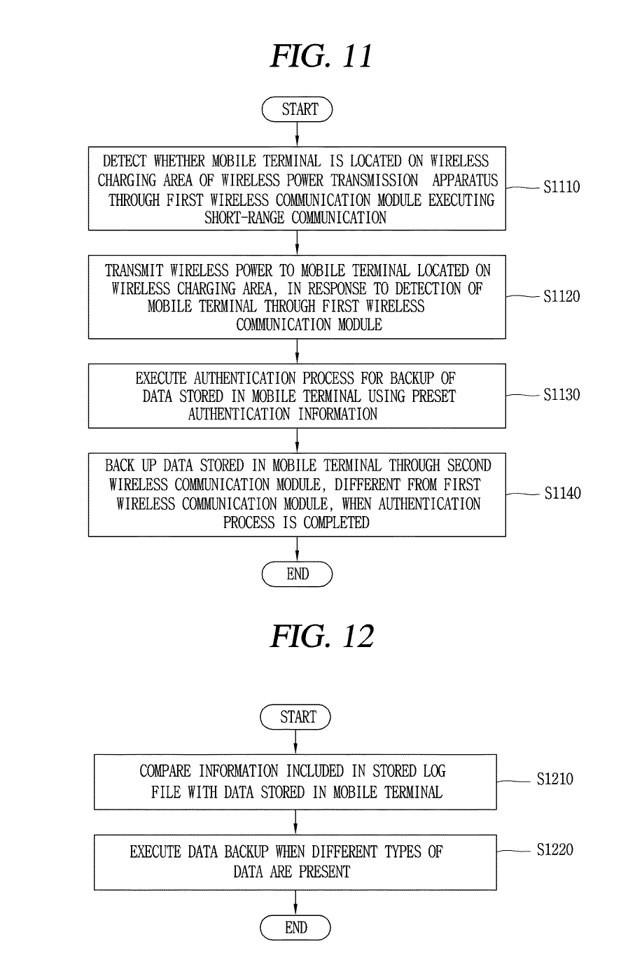

Hereinafter, a method of executing a data backup between the wireless power transmission apparatus 100 and the wireless power reception apparatus 200 will be described in more detail with reference to the accompanying drawings, based on the foregoing description. FIGS. 11 and 12 are flowcharts each illustrating a method of executing the backup function in the wireless power transmission apparatus illustrated in FIGS. 9, 10A and 10B.

Hereinafter, a mobile terminal will be described as an example of the wireless power reception apparatus 200. Hereinafter, the mobile terminal is provided with a reference numeral ‘200’ similar to the wireless power reception apparatus.

According to a process of executing the data backup between the wireless power transmission apparatus 100 and the mobile terminal 200 according to the present invention, whether or not the mobile terminal 200 is present on the wireless charging area 105 (see FIGS. 10A and 10B) of the wireless power transmission apparatus 100 is detected through a first wireless communication module (or the short-range communication module) which performs short-range communication (S1110).

As described above, the short-range communication module of the wireless power transmission apparatus 100 may be the NFC communication module or the NFC tag.

When it is detected through the short distance communication module that the mobile terminal 200 is located on the wireless charging area 105, a process of transmitting power to the mobile terminal 200 existing on the wireless charging area in a wireless manner is executed (S1120). The process of transmitting the wireless power is a function that is performed separate from the data backup function. The wireless power transmission apparatus may basically provide a wireless charging function for the mobile terminal 200.

In addition, when it is detected through the short-range communication module that the mobile terminal 200 is located on the wireless charging area 105, an authentication process for backing up data stored in the mobile terminal is executed using prestored authentication information (S1130).

In the present invention, the execution of the authentication process refers to establishing a state in which the mobile terminal 200 and the wireless power transmission apparatus 100 can transmit and receive backup target data (data to be backed up).

For example, by executing the authentication process, the wireless Internet module (or a second wireless communication module, for example, Wi-Fi module) of the wireless power transmission apparatus 100 and the wireless Internet module (e.g., Wi-Fi module) of the mobile terminal 200 may become an accessed state to each other.

On the other hand, through this authentication process, the authentication information may be transferred from one side to the other or exchanged.

As described above, the authentication information refers to the information that is needed by the communication module (for example, the wireless Internet module or the Wi-Fi module), which is to be used for receiving data stored in the mobile terminal 200 upon the execution of the data backup function, to perform communication with the mobile terminal 200.

Here, the authentication information may include at least one of SSID information, access security method information, and password information related to the wireless Internet module.

That is, the mobile terminal 200 may require at least one of the SSID information, the access security scheme information, and the password information related to the wireless Internet module, in order to perform communication with the wireless Internet module of the wireless power transmission apparatus 100 according to the present invention.

Further, the authentication information may further include a control message for enabling the wireless Internet module of the mobile terminal 200 to be activated.

As such, the wireless power transmission apparatus 100 according to the present invention can assist the data backup function by transmitting the authentication information to the mobile terminal 200 through the short-range wireless communication module.

Meanwhile, the mobile terminal 200 may access the wireless Internet module using the authentication information. In addition, the mobile terminal 200 may switch the wireless Internet module from an inactive state to an active state, in response to the reception of the authentication information, when the wireless Internet module (e.g., the Wi-Fi module) for performing communication with the wireless power transmission apparatus 100 is in the inactive state.

Meanwhile, when the authentication process is completed, data stored in the mobile terminal is backed up through another wireless communication module (or the second wireless communication module) different from the short-range communication module (or the first wireless communication module) (S1140).

When the data backup is executed, the data stored in the mobile terminal 200 is transmitted to the wireless power transmission apparatus 100 through the wireless Internet modules provided in the mobile terminal 200 and the wireless power transmission apparatus 100, respectively.

On the other hand, the data is stored in the memory 170. Further, the data which has been backed up from the mobile terminal and stored in the memory 170 may also be transmitted to an external device or an external server through the wireless Internet module based on a user request. Here, the external device or the external server may be a web hard, a cloud server, or the like.

Meanwhile, when the backup of the data stored in the mobile terminal 200 is completed or while the backup of the data stored in the mobile terminal 200 is executed, the controller 180 of the wireless power transmission apparatus 100 according to the present invention may generate a log file for data, which is stored in the memory 170 of the wireless power transmission apparatus 100 through the backup, among data stored in the mobile terminal 200.

When the backup of the data stored in the mobile terminal is executed again, the controller 180 may decide data to be backed up (backup target data) among the data stored in the mobile terminal, by using the log file.

More specifically, the log file is stored in the memory 170. When the backup with respect to the mobile terminal 200 is performed again, the backup target data may be filtered based on the log file. That is, the controller 180 may skip the backup of the data, which has already been backed up, using the log file.

In other words, the controller may back up data, which is not stored in the memory, among the data stored in the mobile terminal 200, using the log file.

In more detail, referring to FIG. 12, the controller 180 may compare information stored in the stored log file with the data stored in the mobile terminal 200 (S1210). The controller 180 may determine using the log file whether there is backup target data among the data stored in the mobile terminal 200, and then perform the data backup when the backup target data is present among the data stored in the mobile terminal (S1220).

The log information (or the log file) may include log information related to the backed-up data and identification information related to the mobile terminal. Accordingly, when identification information on the mobile terminal to be wirelessly charged matches the identification information stored in the log information, the controller 180 may perform the backup function for the mobile terminal 200 using the log information.

On the other hand, when different types of data are backed up using the log information, the controller 180 may update the log information to include a log of data that has been backed up so far.

Meanwhile, when the backup target data exists as the comparison result in step S1210, the controller 180 may output notification information indicating the presence of the backup target data.

Here, the notification information may be output in various manners, for example, in at least one of audible, tactile, and visual manners.

Here, the visual manner may be configured to turn on or off a lamp (or LED lamp) provided in the wireless power transmission apparatus 100. The controller 180 may output a current state of the wireless power transmission apparatus 100 by controlling the lamp to emit light of a different color.

Further, the controller 180 may also transmit a control message to the mobile terminal 200 so that the notification information can be output on the mobile terminal 200.

Furthermore, when a backup request is received from the user in response to the output of the notification information indicating the presence of the backup target data, the controller 180 may perform the backup for the backup target data.

That is, even if the mobile terminal 200 is detected, the controller 180 may not activate the data backup function unconditionally but activate the data backup function after receiving a permission command from the user.

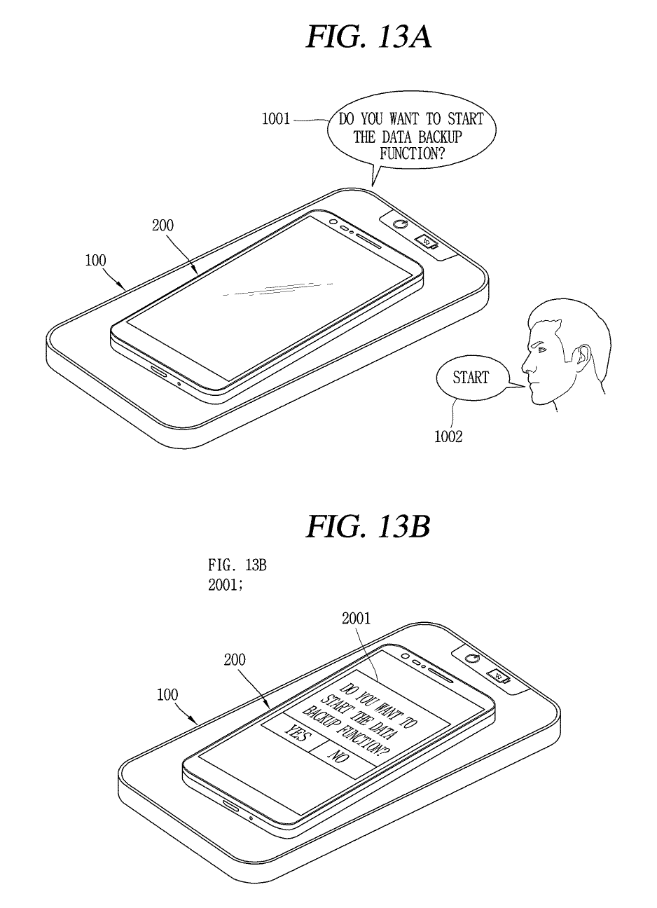

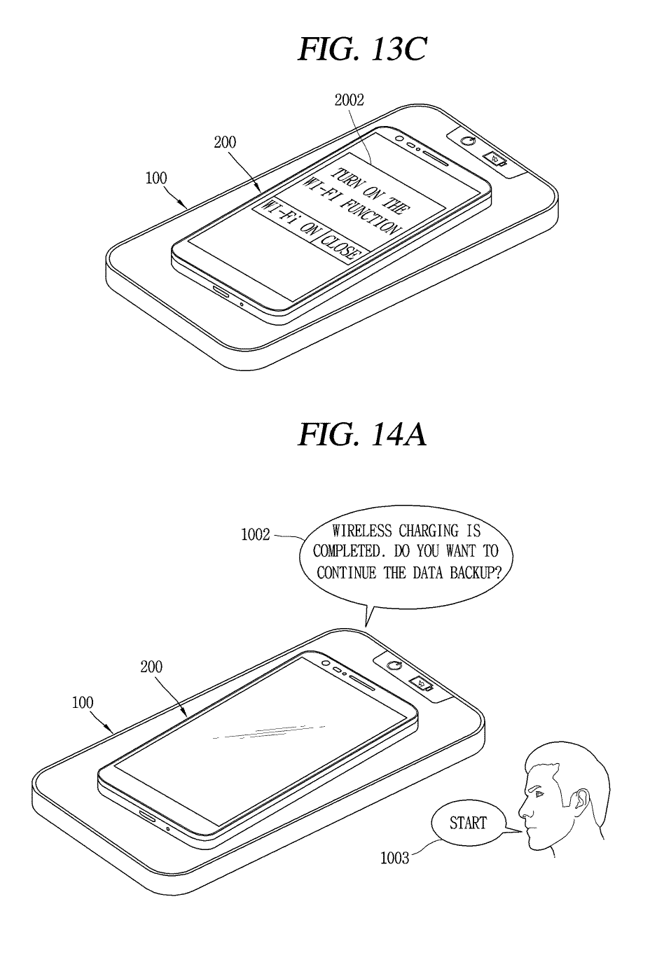

For example, as illustrated in FIG. 13A, notification information 1001 may be output in an audible manner. In addition, a voice recognition function may be utilized for selecting whether or not to perform the data backup function. To this end, the wireless power transmission apparatus according to the present invention may be provided with an audio output unit and a microphone.

When a command (or permission command) 1002 “Start” is input in response to the output of the notification information 1001 “Do you want to start the data backup function?”, the controller 180 may perform the data backup function. Although not illustrated, when a command (or stop command) “Stop” is input, the controller 180 may not perform the data backup function.

On the other hand, when the permission command or the stop command is not received for a preset time after the notification information is output, the controller 180 may stop or continue the data backup function according to a setting value.

Further, the selection of whether or not to perform the data backup function may be made through the mobile terminal 200, as illustrated in FIG. 13B.

In this case, the controller 180 may transmit a selection message (or selection information) to the mobile terminal 200 to select whether or not to perform the data backup function. Based on the selection message, as illustrated in FIG. 13B, the mobile terminal 200 may output a pop-up window 2001 asking whether or not to start the data backup function.

The controller 180 may perform an authentication process for the data backup function when the execution of the data backup function is selected through the pop-up window 2001, while performing only the wireless charging function when it is selected not to start the data backup function.

In addition, as illustrated in FIG. 13C, when the wireless Internet module (for example, Wi-Fi module) of the mobile terminal 200 is in an inactive state despite the fact that the execution of the data backup function has been selected, a pop-up window 2002 may be output to switch the inactive state of the wireless Internet module (e.g., Wi-Fi module). The pop-up window 2002 may be output in response to the controller of the mobile terminal 200 receiving the authentication information from the wireless power transmission apparatus 100.

In addition, when the activation of the Wi-Fi module is selected on the pop-up window 2002, the controller of the mobile terminal 200 may activate a Wi-Fi function and transmit data to be backed up.

Further, when the activation of the Wi-Fi module is not selected on the pop-up window 2002, the mobile terminal 200 and the wireless power transmission apparatus 100 may not perform the data backup function.

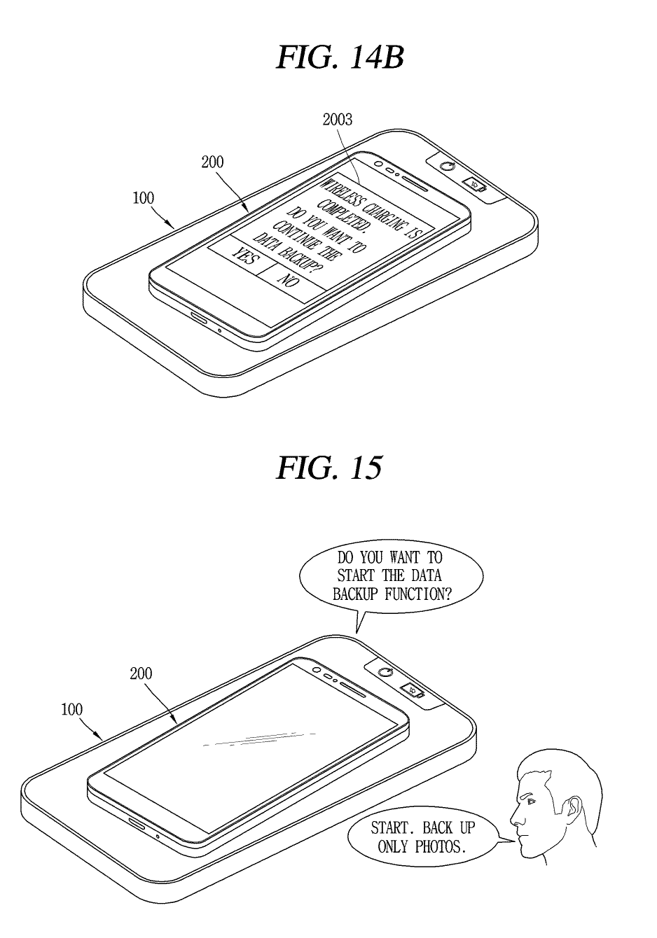

Hereinafter, examples of a method of performing a data backup will be described in more detail with reference to the accompanying drawings. FIGS. 14A, 14B, and 15 are conceptual views illustrating a method of performing a data backup function in a wireless power transmission apparatus or a wireless power reception apparatus according to the present invention.

The wireless power transmission apparatus 100 according to the present invention may perform the data backup function even while the wireless charging function for the mobile terminal 200 is performed. The controller 180 may perform the data backup function using the wireless Internet module even while wireless power is transmitted from the power transmission unit 110 to the mobile terminal.

On the other hand, while the backup function of the data stored in the mobile terminal 200 using the wireless Internet module and the wireless charging function for the mobile terminal 200 using the power transmission unit are simultaneously performed, when the wireless charging for the mobile terminal 200 is completed, the controller 1890 may control the power transmission unit to stop the wireless power transmission to the mobile terminal 200. In this instance, when the data backup function is not completed, the controller 180 may continuously perform the backup function for the data stored in the mobile terminal 200 if the mobile terminal 200 is continuously placed on the wireless charging area 105.

Meanwhile, when any one function is completed while the wireless charging function for the mobile terminal 200 and the backup function for the data stored in the mobile terminal 200 are simultaneously executed, the controller 180 may output selection information to select whether or not to continue the other function which has not been completed yet.

For example, as illustrated in FIG. 14A, an output of selection information 1002 may be output in an audible manner. In addition, the voice recognition function may be utilized to select whether or not to continuously perform the other function that has not been completed yet. To this end, the wireless power transmission apparatus according to the present invention may be provided with an audio output unit and a microphone.

When a command “Continue” (or permission command) 1003 is input in response to the output of the selection information “Wireless charging is completed. Do you want to continue the data backup?”, the controller 180 may continuously execute the data backup function. Although not illustrated, when a command “Stop” (or stop command) is input, the controller 180 may stop the data backup function. In this instance, the controller 180 may generate log information related to data until which has been backed up until before the stop command is applied.

On the other hand, when the permission command or the stop command is not received for a preset time after the selection information is output, the controller 180 may stop or continue the data backup function according to a setting value.

Further, the selection of whether to continue or stop the data backup function may be executed through the mobile terminal 200, as illustrated in FIG. 14B.

In this case, the controller 180 may transmit a selection message (or selection information) to the mobile terminal 200 to select whether to continue or stop the data backup function. Based on this selection message, the mobile terminal 200 may output a pop-up window 2003 asking whether or not to continuously execute the data backup function, as illustrated in FIG. 14B.

The controller 180 may continue to execute the data backup function even though the charging is completed when it is selected to continue the data backup function through the pop-up window 2003, while stopping the data backup function even though the mobile terminal 200 is continuously placed on the wireless charging area 105 when it is selected not to continue the data backup function.

Meanwhile, in the wireless power transmission apparatus according to the present invention, an execution time point of the data backup function for the mobile terminal 200 may vary. The controller 180 may control the backup function to be executed with respect to the data stored in the mobile terminal when the mobile terminal is wirelessly charged with power by a preset level or more.

Here, the charged level of the mobile terminal may be specified based on a user selection.

In addition, the wireless power transmission apparatus according to the present invention may immediately execute the data backup function when the mobile terminal 200 is located on the wireless charging area 105, irrespective of the charged degree or the charged level of the mobile terminal.

On the other hand, in the wireless power transmission apparatus according to the present invention, the data to be backed up may be all kinds of data stored in the mobile terminal 200, or may be data of a specific type. Furthermore, the data to be backed up may be decided based on a user selection. The user may specify the backup target data by selecting on the mobile terminal 200 or the wireless power transmission apparatus 100 at least one condition of type, extension, category and saved date of data to be backed up. The user may back up only photo data or only document files, if necessary.

The user may specify the data to be backed up in various manners. For example, as illustrated in FIG. 15, when information for asking whether or not to execute the data backup function is output, the user may permit the data backup function and simultaneously specify data to be backed up. A voice recognition function may be utilized for this method of specifying data. To this end, the wireless power transmission apparatus according to the present invention may be provided with an audio output unit and a microphone.

Meanwhile, the controller 180 may not activate the data backup function unconditionally even if the mobile terminal 200 is detected but activate the data backup function after receiving a permission command from the user.

When a command word for specifying data to be backed up is simultaneously received with the permission command, the controller 180 may back up only data based on the input command word.

For example, when a data backup permission command “Start” and a command for specifying data “Back up only photos” are simultaneously input by the user, the controller 180 may activate the data backup function and receive only data corresponding to the photos among data stored in the mobile terminal 200.

On the other hand, when the mobile terminal 200 is detected and the data backup function is set to be activated unconditionally, the controller 180 may output information informing that the data backup function is activated through an audio output function. In this case, the user may input a command word for specifying data, in response to the output of such information. The controller 180 may back up only the data based on the command word input by the user.

As described above, a wireless power transmission apparatus according to the present invention may detect that a wireless power reception apparatus is located on a wireless charging area through a short-range communication module, and perform a backup function for data stored in the wireless power reception apparatus in response to the detection. That is, according to the present invention, the data backup function can be performed simultaneously with a wireless charging for the wireless power reception apparatus. Therefore, a user can save time taken by executing the wireless charging function and the data backup function by virtue of the simultaneous use of the both functions.

Further, when the wireless power reception apparatus is detected through the short-range wireless communication module, the wireless power transmission apparatus according to the present invention can perform the data backup function for the wireless power reception apparatus by activating another communication module having a data communication speed higher than that of the short-range wireless communication module. Therefore, according to the present invention, the data backup function can be provided more efficiently by virtue of appropriately using the communication modules for a utilization purpose.

1. A wireless power transmission apparatus comprising:
a first wireless communication module configured to detect a mobile terminal at a wireless charging area of the wireless power transmission apparatus;
a second wireless communication module;
a memory configured to store data;
a controller; and
a power transmission unit configured to wirelessly transmit power to the mobile terminal located at the wireless charging area,
wherein the controller is configured to:
execute, via the first wireless communication module, an authentication process with the mobile terminal using pre-stored authentication information for backing up data stored at the mobile terminal;
receive data stored at the mobile terminal via the second wireless communication module after the authentication process is executed; and
store the received data in the memory as backup data to the data stored at the mobile terminal.

2. The transmission apparatus of claim 1, wherein the controller is further configured to execute the authentication process, receive the data, and store the received data in the memory concurrently with the power transmission unit wirelessly transmitting power to the mobile terminal.

3. The transmission apparatus of claim 2, wherein the controller is further configured to control the power transmission unit to stop transmitting power to the mobile terminal when wireless charging of the mobile terminal is completed and continue receiving the data and storing the data in the memory after wireless charging of the mobile terminal is completed.

4. The transmission apparatus of claim 3, wherein:
the controller is further configured to cause a signal to be transmitted to the mobile terminal to display a message on a display of the mobile terminal when wireless charging of the mobile terminal is completed or storing of the backup data is completed; and
the displayed message comprises a selectable option to continue wireless charging if storing of the backup data is completed or a selectable option to continue storing of the backup data if wireless charging is completed.

5. The transmission apparatus of claim 1, wherein the controller is further configured to execute the authentication process with the mobile terminal only when a charge level of the mobile terminal exceeds a threshold level.

6. The transmission apparatus of claim 1, wherein the controller is further configured to store a log file in the memory when storing of the backup data is completed, wherein the log file indicates the backup data stored in the memory.

7. The transmission apparatus of claim 1, wherein the controller is further configured to only store backup data from the mobile terminal that is not already stored in the memory, according to an existing log file stored in the memory after a previous backup.

8. (canceled)

9. The transmission apparatus of claim 8, wherein the controller is further configured to:
determine whether there exists new data stored at the mobile terminal which has not yet been stored in the memory as backup data according to the existing log file; and
cause a signal to be transmitted to the mobile terminal for displaying a selectable option to initiate backup of the new data.

10. The transmission apparatus of claim 8, wherein the controller is further configured to update the existing log file and store the updated log file in the memory when storing the backup data is completed.

11. The transmission apparatus of claim 1, wherein:
the first communication module is a near field communication (NFC) communication module using a short-range communication protocol method; and
the second communication module is a Wi-Fi communication module configured to communicate with the mobile terminal via a short-range wireless communication network.

12. The transmission apparatus of claim 1, wherein
the first communication module is disposed proximate to the wireless charging area and the apparatus further comprises a magnet configured to magnetically guide positioning of the mobile terminal with respect to the wireless charging area.

13. The transmission apparatus of claim 1, wherein the controller is further configured to transmit at least Service Set Identifier (SSID) information, access security method information, or password information related to the second wireless communication module to the mobile terminal via the first wireless communication module when the mobile terminal is detected at the wireless charging area.

14. The transmission apparatus of claim 1, wherein the controller is further configured to cause a signal to be transmitted to the mobile terminal via the second wireless communication module when the mobile terminal is detected at the wireless charging area, the transmitted signal for displaying at the mobile terminal a selectable option for initiating backup of data stored at the mobile terminal.

15. The transmission apparatus of claim 1, wherein the controller is further configured to transmit the backup data stored in the memory to an external device or external server via the second wireless communication module.

16. A method for controlling a wireless power transmission apparatus, the method comprising:
detecting a mobile terminal at a wireless charging area of the wireless power transmission apparatus;
wirelessly transmitting power to the mobile terminal located at the wireless charging area;
executing an authentication process with the mobile terminal using pre-stored authentication information for backing up data stored at the mobile terminal;
receiving data stored at the mobile terminal after the authentication process is executed; and
storing the received data in a memory of the wireless power transmission apparatus as backup data to the data stored at the mobile terminal.

17. The method of claim 16, wherein executing the authentication process, receiving the data, and storing the received data in the memory is performed concurrently with wirelessly transmitting power to the mobile terminal.

18. The method of claim 17, further comprising stopping transmitting power to the mobile terminal when wireless charging of the mobile terminal is completed and continuing receiving the data and storing the data in the memory after wireless charging of the mobile terminal is completed.

19. The method of claim 16, further comprising storing a log file in the memory when storing of the backup data is completed, wherein the log file indicates the backup data stored in the memory.

20. The method of claim 16, wherein only data from the mobile terminal that is not already stored in the memory is stored as backup data, according to an existing log file stored in the memory after a previous backup.

21. The transmission apparatus of claim 6, wherein the log file comprises identifying information of the mobile terminal.
